(19) United States
(12) Patent Application Publication
(10) Pub. No.: US 2023/0226714 A1
(43) Pub. Date: Jul. 20, 2023

(54) SAW SYSTEMS HAVING INTERCHANGEABLE SAW CARTRIDGES

(71) Applicant: Milwaukee Electric Tool Corporation, Brookfield, WI (US)

(72) Inventors: Scott T. Moeller, Richfield, WI (US); Carter Gibson, New Berlin, WI (US); Peter R. Heath, Wauwatosa, WI (US); John J. Springer, Milwaukee, WI (US)

(21) Appl. No.: 18/095,852

(22) Filed: Jan. 11, 2023

Related U.S. Application Data
(60) Provisional application No. 63/299,800, filed on Jan. 14, 2022.

(51) Int. Cl. B27B 3/30; B27B 17/02; B27B 9/00; B27B 17/00; B27B 17/08

(52) U.S. Cl. CPC B27B 3/30; B27B 9/00; B27B 17/02; B27B 17/0008; B27B 17/08

(57) ABSTRACT

Saw systems are provided. A saw system includes a body and one or more interchangeable saw cartridges. The body includes a prime mover and a transmission element. Activation of the prime mover drives the transmission element. Each of the one or more interchangeable saw cartridges includes a saw blade and is interchangeably connectable to the body. The connection of one of the one or more interchangeable saw cartridges to the body causes the saw blade of the one of the one or more interchangeable saw cartridges to be drivable by the transmission element.

### CROSS REFERENCE TO RELATED APPLICATIONS

The present application claims priority to U.S. Provisional Pat. Application No. 63/299,800 filed on Jan. 14, 2022, the disclosure of which is incorporated by reference herein in its entirety.

### FIELD

The present disclosure relates generally to saw systems, and more particularly to modular saw systems which can utilize one or more interchangeable saw cartridges.

### BACKGROUND

Power tools for cutting various materials are generally known in the art. However, many such power tools, generally referred to herein as saws, can be heavy and cumbersome to use. Further, multiple different types of saws, such as various sizes of chainsaws, circular saws, etc., may be required for a single job. This requires a user to haul multiple heavy and cumbersome tools to and from a jobsite. Still further, when such saws become worn, it can be burdensome and expensive to repair the saws or the saws must be replaced in their entireties.

Accordingly, improved saws are desired in the art. In particular, saw systems which reduce the burden on users transporting power tools to and from a jobsite would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a saw system is provided. The saw system includes a body and one or more interchangeable saw cartridges. The body includes a prime mover and a transmission element. Activation of the prime mover drives the transmission element. Each of the one or more interchangeable saw cartridges includes a saw blade and is interchangeably connectable to the body. The connection of one of the one or more interchangeable saw cartridges to the body causes the saw blade of the one of the one or more interchangeable saw cartridges to be drivable by the transmission element.

In accordance with another embodiment, a method of operating a saw system is provided. The method includes connecting one of a plurality of interchangeable saw cartridges to a body. The body includes a prime mover and a transmission element, wherein activation of the prime mover drives the transmission element. Each of the plurality of interchangeable saw cartridges includes a saw blade and is interchangeably connectable to the body, wherein the connection of the one of the plurality of interchangeable saw cartridges to the body causes the saw blade of the one of the plurality of interchangeable saw cartridges to be drivable by the transmission element. The method further includes activating the prime mover to drive the transmission element, such that the transmission element drives the saw blade of the one of the plurality of interchangeable saw cartridges. The method further includes removing the connected one of the plurality of interchangeable saw cartridges from the body. The method further includes connecting a different one of the plurality of interchangeable saw cartridges to the body. The method further includes activating the prime mover to drive the transmission element, such that the transmission element drives the saw blade of the different one of the plurality of interchangeable saw cartridges.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 illustrates a saw system in accordance with embodiments of the present disclosure;

FIG. 2 illustrates a saw system body with an interchangeable saw cartridge connected thereto in accordance with embodiments of the present disclosure; and

FIG. 3 illustrates a saw system connection assembly in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure is directed to improved saw systems. Saw systems in accordance with the present disclosure allow for more efficient tool transportation to and from a worksite. Further, saw systems in accordance with the present disclosure provide ease of use and ease of switching between various saw-type power tools when multiple of such tools are required for a job.

Saw systems in accordance with the present disclosure generally include a saw system body and one or more, such as in exemplary embodiments a plurality of, interchangeable saw cartridges. Each of the one or more interchangeable saw cartridges may be independently connectable to the saw system body. When connected, operation of the saw system body, such as via activation of a prime mover housed in the body, may cause operation of the saw cartridge connected to the body.

Each of the interchangeable saw cartridges may have a different form factor from one or more, such as in some embodiments all, of the other interchangeable saw cartridges in the saw system. For example, the size, shape, orientation, type of saw blade, and/or other characteristics may differ between each of the interchangeable saw cartridges and one or more, such as in some embodiments all, of the other interchangeable saw cartridges in the saw system. In some embodiments, for example, an interchangeable saw cartridge may include a chainsaw blade (including a guide bar and chain), a circular saw blade, a reciprocating saw blade, a jig saw blade, or another suitable saw blade. Further, the lengths, widths, and thicknesses of such saw blades can vary between cartridges. In some embodiments, various interchangeable saw cartridges may be provided with features that can be utilized for specific trades and/or applications, such as framing; general carpentry; mechanical, electrical and plumbing; demolition, etc. In some embodiments, various interchangeable saw cartridges may be provided with features that can be utilized for cutting different materials, such as woods; plastics; metals, etc.

In some exemplary embodiments, the interchangeable saw cartridges can be disposable. Accordingly, when a saw blade is worn out, the cartridge can be disposed of and a new cartridge purchased for use with the same saw system body.

Each interchangeable saw cartridge may be interchangeably connected to the saw system body. For example, each interchangeable saw cartridge may include a cartridge body which is connectable to a mount portion of the saw system body. Mating faces of the cartridge body and mount portion may have corresponding profiles, such that the cartridge body of each interchangeable saw cartridge is seatable on the mount portion. The cartridge body and saw system body may include one or more mount features, such mating protrusions and depressions, which serve to locate the cartridge body relative to the saw system body and mount portion thereof. A transmission element of the saw system body, such as an output shaft which is connected or geared to the prime mover, may be connectable to a transmission assembly and/or saw blade of the interchangeable saw cartridge which is connected to the saw system body. This connection causes operation of the saw blade when the saw system body is operated.

In some exemplary embodiments, the interchangeable saw cartridges may each be connected to the saw system body without the use of separate tools.

In some exemplary embodiments, the interchangeable saw cartridges are oil-less saw cartridges, thus eliminating the need for any oiling systems for the saw blades.

In some exemplary embodiments, the interchangeable saw cartridges which utilize chainsaw blades (including a guide bar and chain) include self-tensioning features, thus reducing the risk of the chains falling off or becoming disengaged during use or when such interchangeable saw cartridges are being removed from or connected to the saw system body.

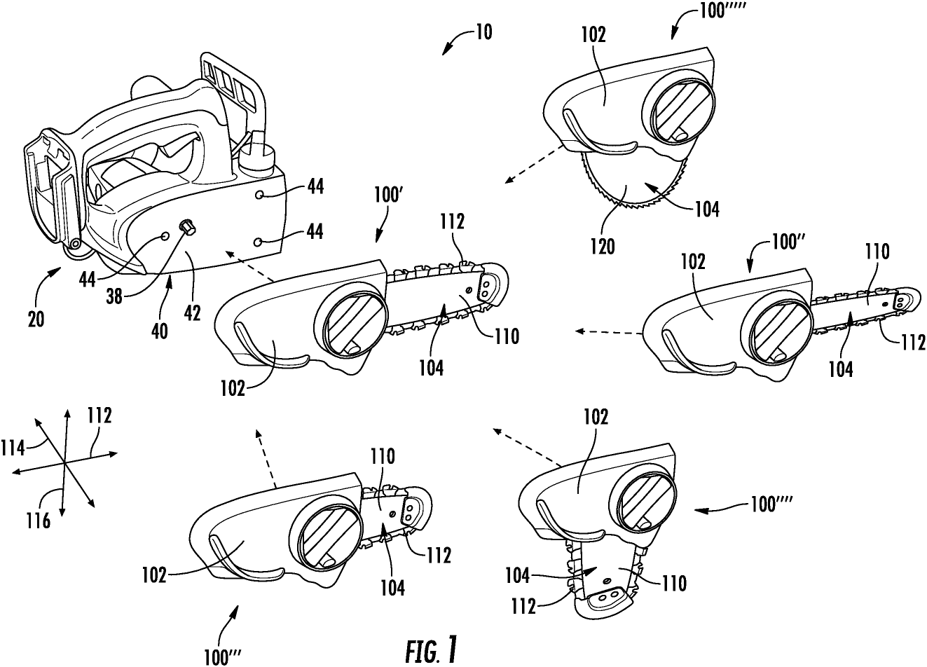

Referring now to the drawings, FIG. 1 illustrates a saw system 10 in accordance with embodiments of the present disclosure. As shown, saw system 10 may include a saw system body 20 and one or more, such as in exemplary embodiments a plurality of, interchangeable saw cartridges 100′, 100″, 100‴, 100′′′′, 100′′′′′ (collectively cartridge(s) 100). Each cartridge 100 may be interchangeably connected to the saw system body 20, and may be operable when connected to the saw system body 20.

A coordinate system may be defined for a saw system 10, and may include a longitudinal axis 112, lateral axis 114, and transverse axis 116. The coordinate system may be defined by the body 20 and/or a cartridge 100 connected to the body 20.

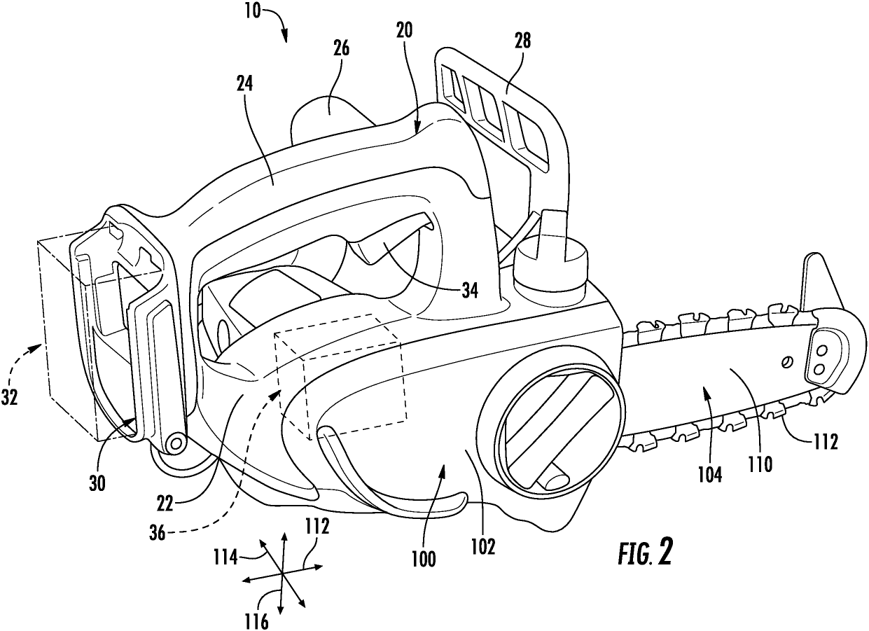

Referring now also to FIG. 2, body 20 may include a housing 22 from which one or more handles, such as a first handle 24 and a second handle 26, extend. First handle 24 may extend from the housing 22 along the transverse axis 116, and may be oriented longitudinally. Second handle 26 may extend from the housing 22 along lateral axis 114, and may extend laterally. Body 20 may further include a handguard 28 extending from the housing 22 at a longitudinal front end of the body 20. In exemplary embodiments, handguard 28 may be operably coupled to a braking mechanism of the saw system, which may be disposed within the housing 22 and which may be operable to brake a prime mover of the saw system 10.

In exemplary embodiments, body 20 may further include a battery receiving area 30 which can receive one or more batteries 32 to power the saw system 10. Additionally or alternatively, saw system 10 may include a plug or plug receptacle for receiving electrical power from a power cord via an external power source such as a wall socket.

A user interface 34, such as a trigger, can be disposed at a location whereby an operator can control operation of the saw system 10. For example, user interface 34 can be disposed on body 20, such as on first handle 24. The user interface 34 can control a prime mover 36 of the saw system 10. Prime mover 36 may be disposed within the housing 22. In exemplary embodiments, prime mover 36 is an electric motor. Alternatively, prime mover 36 may be a gas-powered engine or other suitable prime mover. An output of the prime mover 36 may directly or indirectly (such as via a gearbox) drive a transmission element 38, which may in turn drive a saw blade of an interchangeable saw cartridge 100 connected to the body 20. Transmission element 38 may, for example, be an output shaft of the prime mover 36.

When the user interface 34 is activated, e.g., depressed, the speed of the prime mover can increase. Conversely, when the user interface 34 is deactivated, e.g., not depressed, the prime mover can stop. In certain instances, the prime mover can be a variable speed motor and a relative activated position of the user interface 34 can inform the speed of the variable speed motor. That is, the operator can control the speed of the prime mover, and thus control the speed of the saw blade 104 of the interchangeable saw cartridge 100 connected to the body 20.

Referring again to FIG. 1, saw system may include one or more, such as in exemplary embodiments a plurality of, interchangeable saw cartridges 100′, 100″, 100‴, 100′′′′, 100′′′′′. Each cartridge 100 may be interchangeably connected to the saw system body 20 and may be operable when connected to the saw system body 20. Each cartridge 100 may include a cartridge body 102 and a saw blade 104. In exemplary embodiments, each cartridge 100 may have a different form factor. Further, the cartridge bodies 102 of each cartridge 100 may be identical or substantially identical, thus facilitating interchangeability. However, the saw blades 104 of each cartridge 100 may a different form factor from the saw blades 104 of other interchangeable saw cartridges 100, such that the interchangeable saw cartridges 100 in general have different form factors from each other.

For example, as shown, the saw blade 104 of cartridge 100′ may be a chainsaw blade which includes a guide bar 110 and a chain 112. The saw blade 104 of cartridge 100″, cartridge 100‴, and cartridge 100⁗ may also each be a chainsaw blade which includes a guide bar 110 and a chain 112. The saw blade 104 of cartridge 100′ may be relatively longer than that of cartridge 100‴, and may be relatively wider than that of cartridge 100″. The saw blade 104 of cartridge 100″ may be relatively thinner than that of cartridge 100‴, and may be relatively longer than that of cartridge 100′. The saw blade 104 of cartridge 100‴ may be relatively shorter than that of cartridge 100′, and may be relatively wider than that of cartridge 100″. The saw blade 104 of cartridge 100⁗ may have a different orientation (for example, extending along the transverse axis 116) from that of the saw blades 104 of cartridges 100′, 100″, 100‴ (for example, extending along the longitudinal axis 112). The saw blade 104 of cartridge 100′′′′ may further have a different length, width, and/or thickness of one or more the saw blades 104 of cartridges 100′, 100″, 100‴. The saw blade 104 of cartridge 100′′′′′ may be a circular saw blade 120 which includes integral saw teeth, such that no separate chain is necessary.

One or more of these and other suitable characteristics such as size, shape, orientation, type of saw blade, etc. many vary between the interchangeable saw cartridges 100. Further, suitable saw blade 104 types include chainsaw blades, circular saw blades, reciprocating saw blades, jig saw blades, etc.

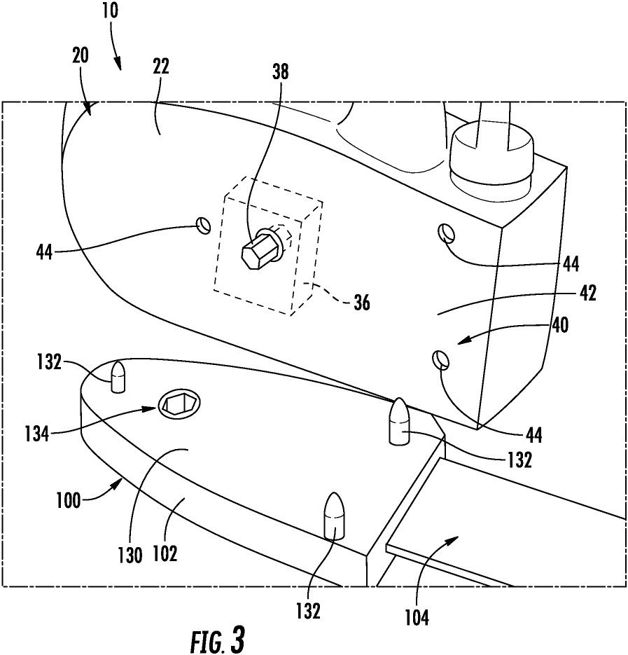

Referring now to FIG. 3, a saw system connection assembly, including a cartridge body 102 of an interchangeable saw cartridge 100 and a mount portion 40 of a saw system body 20, is shown. As discussed, the cartridge body 102 of each interchangeable saw cartridge 100 may be interchangeably connected to the mount portion 40. When connected, operation of the saw system 10, such as via activation of the prime mover 36, may cause operation of the connected saw cartridge 100.

In some exemplary embodiments, cartridge 100 may include a mount face 130 and one or more mount features 132, such as protrusions as shown and/or depressions, on the mount face 130. Mount portion 40 may include a mount face 42 and one or more mount features 44, such as depressions as shown and/or protrusions, on the mount face 42. When connecting an interchangeable saw cartridge 100 to the saw system body 20, the corresponding mounting features may be mated together. For example, in the case where mating protrusions and depressions are utilized, the protrusions may be inserted into the depressions. The mounting features may thus serve to locate the cartridge body 102 and cartridge 100 generally relative to the mount portion 40 and saw system body 20 generally, and may further serve to connect the cartridge body 102 and cartridge 100 generally relative to the mount portion 40 and saw system body 20 generally.

In exemplary embodiments, other suitable connecting features such as connecting latches, locks, etc. may be provided on the cartridge bodies 102 of the interchangeable saw cartridges 100 and on the saw system body 20 to connect the interchangeable saw cartridges 100 to the saw system body 20.

As discussed, body 20 includes a transmission element 38 which is driven by the prime mover 36. Transmission element 38 may, for example, extend from body 20, such as from the mount portion 40. Each of the interchangeable saw cartridges 100 may include features which are mateable with the transmission element 38 such that power (e.g. torque) transmitted from the prime mover 36 to the transmission element 38 is in turn transmitted from the transmission element 38 to the saw blade 104 of a connected cartridge 100. For example, a transmission aperture 134 may be defined in the mount face 130 of each saw cartridge 100, and the transmission element 38 may extend into the cartridge body 102 of a connected cartridge 100 through the aperture 134. Within the cartridge body 102, the transmission element 38 may directly engage the saw blade 104 of the connected cartridge, or may engage a transmission assembly (which may include one or more gears) in the cartridge body 102 which in turn engages the saw blade 104 of the connected cartridge.

Accordingly, for each interchangeable saw cartridge, when the cartridge 100 is connected to the body 20, the saw blade 104 of that cartridge is operable due to operation of the body 20 and system 10 generally. Activation of the user interface 34 may activate the prime mover 36, which may in turn transmit power to the transmission element 38, which may in turn transmit power to the saw blade 104 of the connected cartridge 100. Due to the interchangeability of the cartridges 100, a connected cartridge 100 can be removed and a different cartridge can be connected, and that cartridge 100 may then be similarly operable due to operation of the body 20 and system 10 generally.

Further aspects of the invention are provided by one or more of the following embodiments:

A saw system including a body and one or more interchangeable saw cartridges. The body includes a prime mover and a transmission element. Activation of the prime mover drives the transmission element. Each of the one or more interchangeable saw cartridges includes a saw blade and is interchangeably connectable to the body. The connection of one of the one or more interchangeable saw cartridges to the body causes the saw blade of the one of the one or more interchangeable saw cartridges to be drivable by the transmission element.

A saw system of any one or more of the embodiments described herein, wherein each of the one or more interchangeable saw cartridges has a different form factor from others of the one or more interchangeable saw cartridges.

A saw system of any one or more of the embodiments described herein, wherein each of the one or more interchangeable saw cartridges has a cartridge body and a saw blade, and wherein the saw blade is one of a chainsaw blade, a circular saw blade, a reciprocating saw blade, or a jig saw blade.

A saw system of any one or more of the embodiments described herein, wherein the body has a mount portion having a mount face and one or more mount features, and wherein each of the one or more interchangeable saw cartridges has a mount face and one or more corresponding mount features.

A saw system in accordance with one or more embodiments as shown and described herein.

A saw system body in accordance with one or more embodiments as shown and described herein.

An interchangeable saw cartridge in accordance with one or more embodiments as shown and described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A saw system, comprising:
a body, the body comprising a prime mover and a transmission element, wherein activation of the prime mover drives the transmission element;
one or more interchangeable saw cartridges, each of the one or more interchangeable saw cartridges comprising a saw blade and interchangeably connectable to the body, wherein the connection of one of the one or more interchangeable saw cartridges to the body causes the saw blade of the one of the one or more interchangeable saw cartridges to be drivable by the transmission element.

2. The saw system of claim 1, wherein each of the one or more interchangeable saw cartridges has a different form factor from others of the one or more interchangeable saw cartridges.

3. The saw system of claim 1, wherein each of the one or more interchangeable saw cartridges comprises a cartridge body and a saw blade, and wherein the saw blade is one of a chainsaw blade, a circular saw blade, a reciprocating saw blade, or a jig saw blade.

4. The saw system of claim 1, wherein the body comprises a mount portion comprising a mount face and one or more mount features, and wherein each of the one or more interchangeable saw cartridges comprises a mount face and one or more corresponding mount features.

5. The saw system of claim 4, wherein the mount features comprise at least one of protrusions or depressions, and wherein the corresponding mount features comprise at least the other of protrusions or depressions.

6. The saw system of claim 1, wherein the transmission element extends from the body and is insertable into a transmission aperture defined in a mount face of each of the one or more interchangeable saw cartridges.

7. The saw system of claim 1, wherein each of the one or more interchangeable saw cartridges comprises a cartridge body and a saw blade, wherein each saw blade of the one or more interchangeable saw cartridges has a different form factor from other saw blades of the one or more interchangeable saw cartridges, and wherein each cartridge body of the one or more interchangeable saw cartridges is substantially identical to other cartridge bodies of the one or more interchangeable saw cartridges.

8. The saw system of claim 1, wherein at least one saw blade of the one or more interchangeable saw cartridges comprises a guide bar and a chain.

9. The saw system of claim 1, wherein the body comprises a housing and one or more handles extending from the housing, and wherein the prime mover is disposed within the housing.

10. The saw system of claim 1, wherein the prime mover is an electric motor.

11. The saw system of claim 1, wherein the prime mover is a variable speed motor.

12. The saw system of claim 1, wherein the body includes a battery receiving area.

13. The saw system of claim 1, further comprising a user interface disposed on the body, wherein the prime mover is controlled by the user interface.

14. The saw system of claim 13, wherein the user interface includes a trigger.

15. The saw system of claim 1, wherein the one or more interchangeable saw cartridges are oil-less saw cartridges.

16. The saw system of claim 1, wherein the one or more interchangeable saw cartridges are interchangeably connectable to the body without the use of separate tools.

17. A method for operating a saw system, the method comprising:
connecting one of a plurality of interchangeable saw cartridges to a body, the body comprising a prime mover and a transmission element, wherein activation of the prime mover drives the transmission element, each of the plurality of interchangeable saw cartridges comprising a saw blade and interchangeably connectable to the body, wherein the connection of the one of the plurality of interchangeable saw cartridges to the body causes the saw blade of the one of the plurality of interchangeable saw cartridges to be drivable by the transmission element;
activating the prime mover to drive the transmission element, such that the transmission element drives the saw blade of the one of the plurality of interchangeable saw cartridges;
removing the connected one of the plurality of interchangeable saw cartridges from the body;
connecting a different one of the plurality of interchangeable saw cartridges to the body; and
activating the prime mover to drive the transmission element, such that the transmission element drives the saw blade of the different one of the plurality of interchangeable saw cartridges.

18. The method of claim 17, wherein each of the plurality of interchangeable saw cartridges has a different form factor from others of the one or more interchangeable saw cartridges.

19. The method of claim 17, wherein each of the plurality of interchangeable saw cartridges comprises a cartridge body and a saw blade, and wherein the saw blade is one of a chainsaw blade, a circular saw blade, a reciprocating saw blade, or a jig saw blade.

20. The method of claim 17, wherein the transmission element extends from the body and is insertable into a transmission aperture defined in a mount face of each of the plurality of interchangeable saw cartridges.
